(19) United States
(12) Patent Application Publication
(10) Pub. No.: US 2003/0212706 A1
(43) Pub. Date: Nov. 13, 2003

(54) Patent management system

(76) Inventor: Yu Li Shih, Taipei (TW)

Correspondence Address: JACOBSON HOLMAN PLLC, 400 SEVENTH STREET N.W., SUITE 600, WASHINGTON, DC, 20004, US

(21) Appl. No.: 10/139,221

(22) Filed: May 7, 2002

(51) Int. Cl. G06F 17/00

(52) U.S. Cl. 707/104.1

(57) ABSTRACT

A patent management system that can be applied to a client/server network. The system enables client ends to connect to the server and operate through single PC operations off-line. By using the system, clients can execute data uploading to the system on-line following completion of single PC operations off-line, and the system automatically processes data comparisons and searches for instant data updates. The disclosed system, designed for internal patent data, aims at improving relevant operation flows and process patterns in conventional patent applications to achieve instant management of a patent database.

### BACKGROUND OF THE INVENTION

1. Field of the Invention

The invention relates to a database management system, in particular, a kind of patent management system that employs a client/server network to operate.

2. Related Art

It is an undoubted fact that “intellectual property rights” is of value and a matter of great importance in the twenty-first century. As Taiwan becomes a main country of global IT productions, and as IT technologies are constantly improved in the industry, it is far more important to employ intellectual property rights to heighten competition in the industry so as to keep up with the times. Intellectual property rights not only facilitate promotions of technologies, but also improve economic efficiency in making a monopoly of the market. There has been a serious impact of intellectual property rights on research and development (R&D) in enterprises and on keen competition in the market. Therefore, most enterprises consider intellectual property rights to be one of the essential competitive strategies of their companies, and they carry out this strategy with vigor.

Management of intellectual property rights in the past usually proceeded through either manual operations or spreadsheets. However, when sharing data on spreadsheets among clients, only one person is able to operate at one time, and data cannot be simultaneously updated. The disadvantages of this kind of conventional operation include inefficient performance, incapacity for instant data updating, and prior inquiry if there is another client on-line. The purpose of this is to avoid data loss of other clients while there are more than two clients operating the same spreadsheet on-line simultaneously. Besides, it wastes a client's time to duplicate and paste files one after another, if the same patent is applied in different districts or regions (such as in Taiwan, Mainland China and the USA). That is, a client has to replace the application column with other applied countries after the case in Taiwan has been completed. Thus, it is necessary to establish an easy and convenient database management system for patents to resolve such problems.

### SUMMARY OF THE INVENTION

The disclosed invention aims at resolving the above-mentioned problems by proposing a patent management system, which is an integrated system applying to database management system for patents. The major objective of the patent management system is to improve relevant operation flows and process modules in conventional patent applications. The system adapts a client/server network connecting from clients to the server and provides a mechanism of off-line operations at client ends. Therefore, the system enables a client to operate from a single PC when the network is congested or the bandwidth is insufficient. Moreover, the system enables data to be uploaded to the server after data is updated off-line. This is to assist patent managers, inventors, all employees and even higher-level managers in utilizing the mechanism and functions provided by the system to process examination and inquiry for immediately acquiring the latest strategies of intellectual property rights and various detailed data of an enterprise.

The invention includes at least the following modules: a patent management server system, which is established at the server end to provide access to a plurality of patent management functions through the client/server network; and a patent management client system, which is established at the client end to connect and access the patent management server system, and, when disconnected from the patent management server system, to execute a plurality of patent management functions off-line.

### BRIEF DESCRIPTION OF THE DRAWINGS

FIG. 1 shows a systematic structure of the disclosed patent management system;

FIG. 2 shows the structure of the patent module of the disclosed invention;

FIG. 3 shows a structural representation of the application record unit of the disclosed invention;

FIG. 4 shows a structural representation of the evaluation statistic unit of the disclosed invention;

FIG. 5 shows a structural representation of the inventor check unit of the disclosed invention;

FIG. 6 shows a structural representation of the supervisor check unit of the disclosed invention;

FIG. 7 shows the structure of the update module of the disclosed invention;

FIG. 8 shows a flowchart representation of the instant update method of the invention;

FIG. 9 shows an on-line representation of the invention; and

FIG. 10 shows a functional structure of the invention;

### DETAILED DESCRIPTION OF THE INVENTION

The disclosed invention proposes a patent management system to improve relevant operations and process flows of patent applications. The system provides an off-line mechanism, which mainly includes three modules respectively processing related operations of patent management, calling and responding, and instant database updates. The patent management system enables a plurality of clients to operate the system on-line, connect to the network and simultaneously update the database, or download data to a PC for operation off-line, so as to resolve the problems of network congestion or disconnection. The system automatically checks data changes to update data in the server through an upload function execution by a client, when the client finishes data modification. Moreover, there is no limit the number of clients who can operate the system.

If repeated operations are necessary when the same patent is submitted in different districts or regions (e.g. Taiwan, Mainland China, and the USA), the disclosed system enables a client to merely click and select Taiwan, Mainland China and the USA and it automatically generates three records in the system to eliminate wasted time of the patent management staff and heighten working efficiency. As the system is connected through the network, and data in the database is instantly updated, this data can be synchronously integrated and shared within the enterprise.

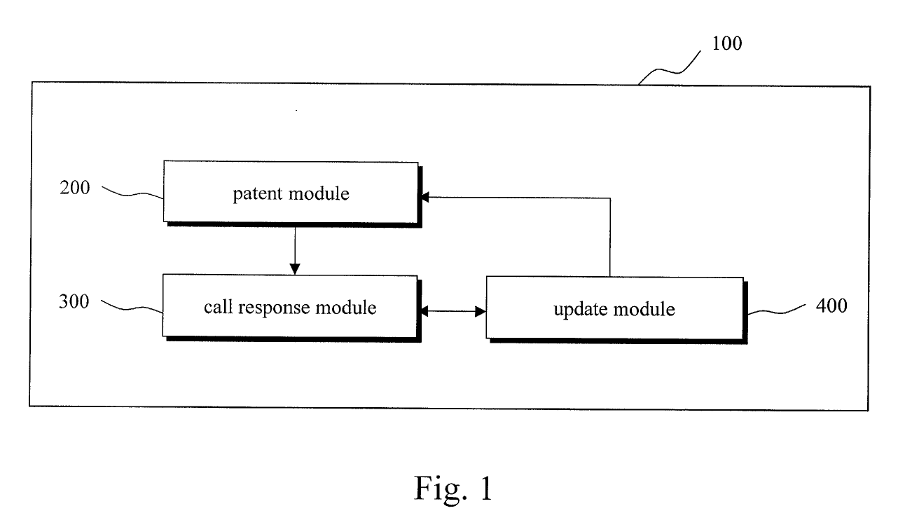

A preferred embodiment is shown to illustrate the feasibility of the invention. As shown in FIG. 1, the systematic structure of the disclosed patent management system 100 includes (1) a patent module 200, (2) a call response module 300 and (3) an update module 400. The detailed descriptions are as follows.

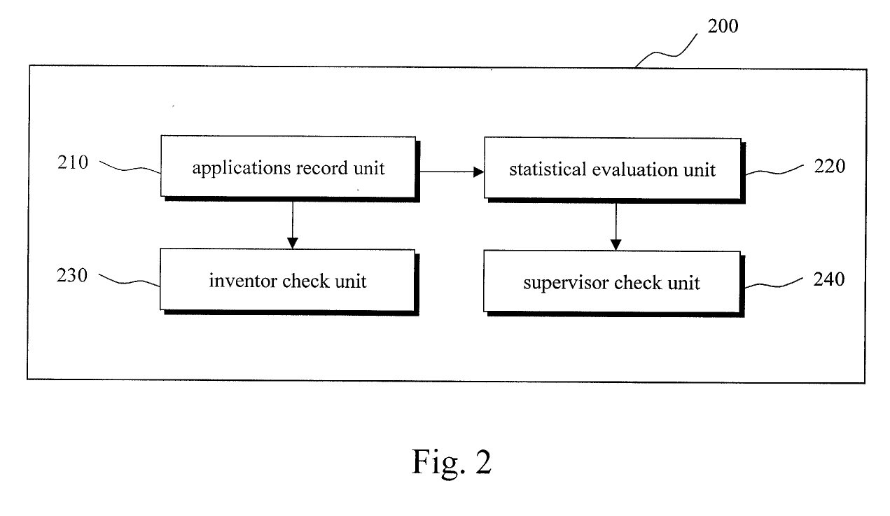

(1) Referring to FIG. 2, the patent module 200 consists of four units: (a) an application record unit 210, (b) a statistical evaluation unit 220, (c) an inventor check unit 230, and (d) a supervisor check unit 240. The details of the units are described as follows.

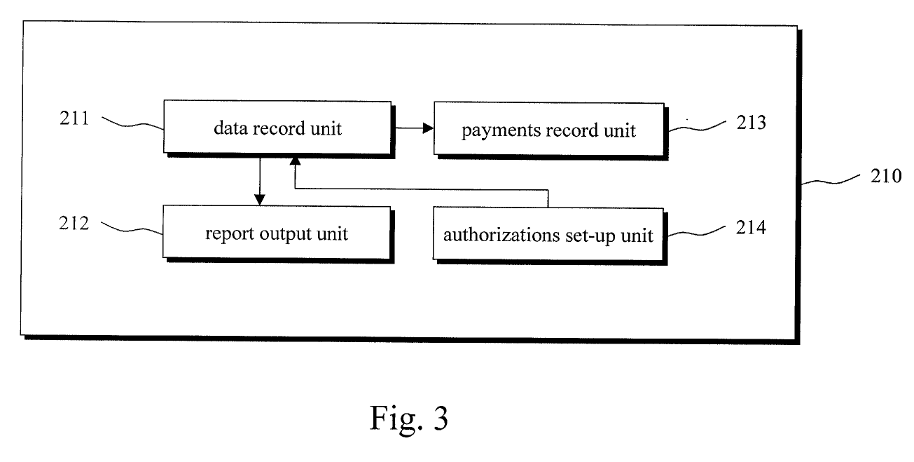

(a) Refer to FIG. 3 for description of the application record unit 210.

The application record unit 210 processes the operations of patent applications (the gateway for patent management staff), which replace the past method of a single PC operation by patent management staff. It utilizes the patent management system 100 for proceeding data management, payment management and maintenance management (e.g. things-to-do, case statistics, application fees, bonuses and annual fees for patents, etc.). The unit further enables patent management staff to set up client authorizations in the system to enhance operations and management patterns. It further contains a data record unit 211, a report output unit 212, a payment record unit 213, and an authorization set-up unit 214. These units are respectively utilized for recording patent data, outputting reports and checklists of patents, recording payment history of patents, recording the examination set-up and inquiring client authorizations of patents.

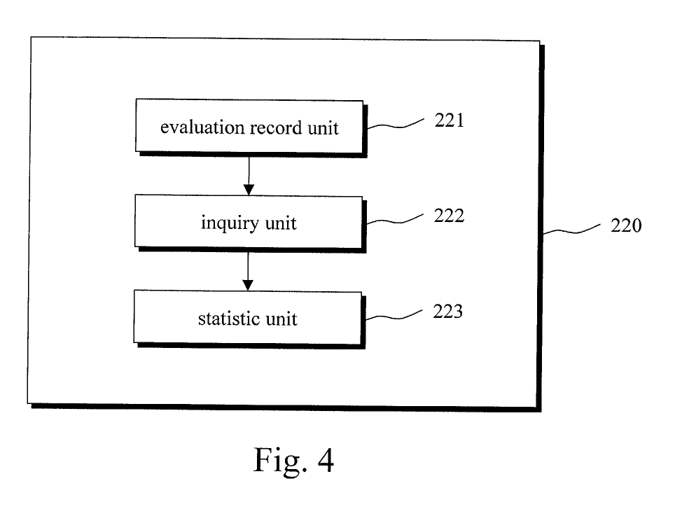

(b) Refer to FIG. 4 for description of the statistical evaluation unit 220.

The statistical evaluation unit 220 is utilized for integrating the whole reports of patents taken out by subsidiaries of an enterprise, integrating all patent data within the enterprise, processing internal evaluations of inventions for patent applications, and recording various results from internal evaluations (e.g. products, technologies, application mechanism, dates for going public, patent categories, priorities, etc.). It further contains an evaluation record unit 221, an inquiry unit 222 and a statistic unit 223. These units are respectively utilized for recording evaluation data of patents, inquiring patent data and calculating patent data that matches searching conditions.

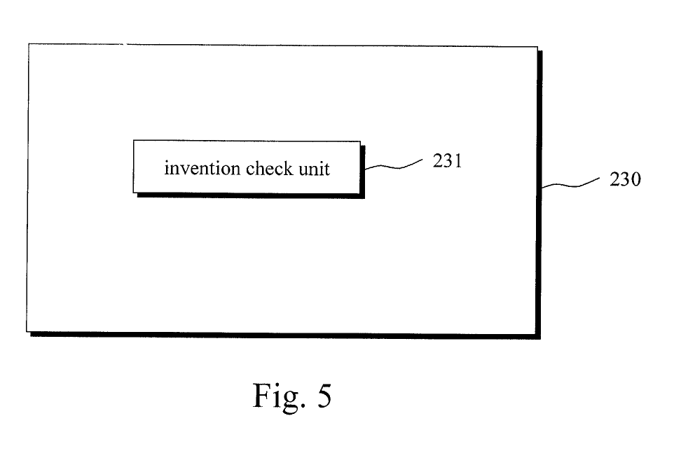

(c) Refer to FIG. 5 for description of the inventor check unit 230.

The inventor check unit 230 is utilized for searching records of applied patent case numbers by inventors (i.e. the gateway for inventors) and checking the detailed inventor data of applied patents (e.g. the company, the department, inventors, patent names, application dates, case serial numbers, applied countries, technology categories, technical points, etc.). It further provides the functions of inquiries and authorizations checks, which are different from other clients, to inventors. The unit further consists of an invention check unit 231 to check detailed results from searched data.

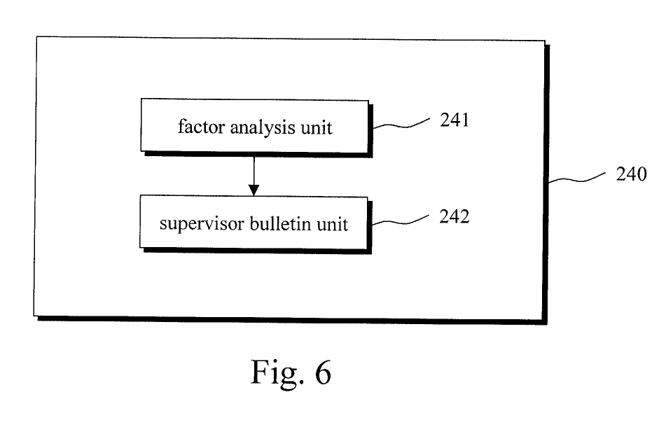

(d) Refer to FIG. 6 for description of the supervisor check unit 240.

The supervisor check unit 240 provides a supervisor bulletin mechanism (i.e. the gateway for supervisors). It enables supervisors to rapidly understand the present patent application status and other summery data through displays of the latest results and various inquiries, as a reference for decision-makings in an enterprise. The unit further consists of a factor analysis unit 241 and a supervisor bulletin unit 242. These units are respectively utilized for analyzing outputs of the statistical evaluation unit and transferring outputs of the factor analysis unit into data requirements for high-level managers.

(2) The call response module 300 receives messages from a client end, respond s with uploading permission, calls a server for executing uploads, and checks updated records of patent data at the server end.

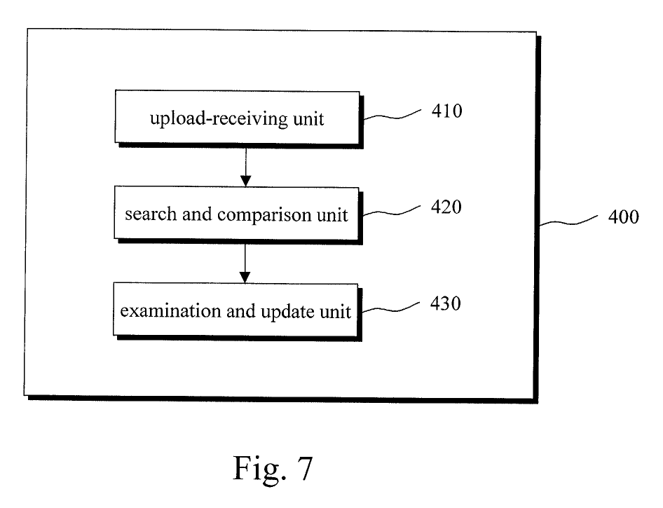

(3) Refer to FIG. 7 for description of the update module 400.

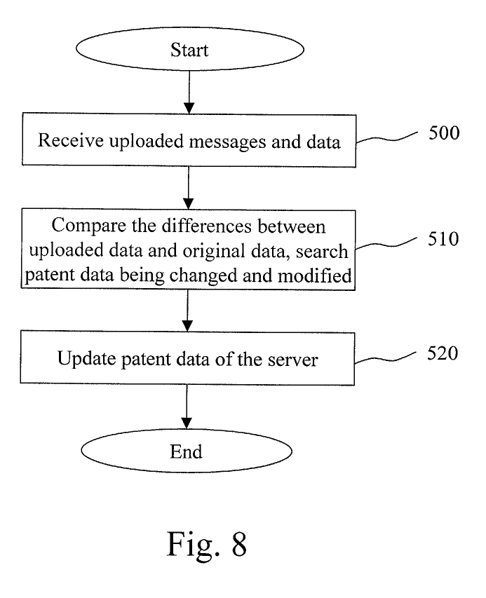

The update module 400 processes the off-line mechanism of operating the patent management system 100. With this mechanism, a client is able to select a single PC to operate the functions of inputting, inquiring, etc., as long as the client has previously downloaded execution files of the patent management system 100 and completed installation of a PC. The module enables the client to start the “upload” function, connecting with the server after completion of PC operations. With reference to FIG. 8, when a client sends out upload message to the server, the upload-receiving unit 410 processes receiving and waits for the server to receive an uploading message and data (step 500). The search and comparison unit 420 then compares the uploaded data and original data, and inquires patent data that is changed and modified (step 510). The examination and update unit 430 updates the patent data in the server (step 520). During data updating, if the updated field is null (remains blank); the original data is not changed; otherwise the original data is replaced by the updated data.

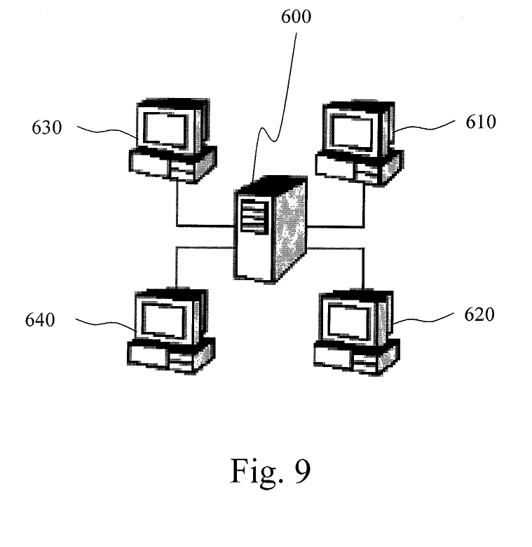

With reference to FIG. 9, the on-line representation of the disclosed patent management system further describes the concept of the client/server network to the instant patent management system as follows.

The disclosed patent management system 100 is internally installed in the server 600 of an enterprise. A client has to have already downloaded execution files of the patent management system 100 and completed installation of a PC, as shown in FIG. 8. Assuming that there are four clients, the PC of client I 610, the PC of client II 620, the PC of client III 630 and the PC of client IV 640, completing personal computer installation, they are able to operate the patent management system 100 off-line. Moreover, different clients can obtain different authorizations to operate and execute functions that are the same operations as on-line. If a client is only entitled to check authorization, the client can not execute the function of uploading. When the other three clients complete uploading operations, the upload-receiving unit 410 can evaluate and record uploading time and data from each client to update data in the server 600 according to priorities of uploading times.

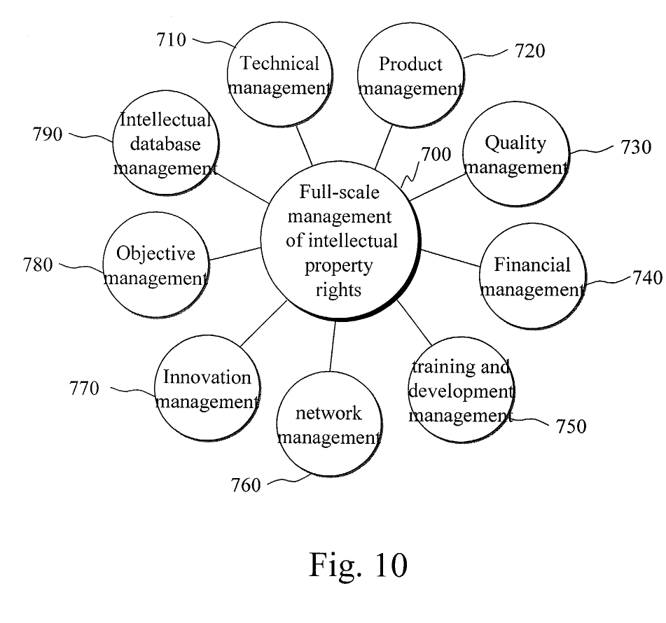

With reference to FIG. 10, the functional structure of the disclosed patent management system further describes the functions of the patent management system as follows.

The disclosed patent management system 100 provides an integrated pattern for full-scale management of intellectual property rights, including technical management 710, product management 720, quality management 730, financial management 740, training and development management 750, network management 760, innovation management 770, objective management 780, and intellectual database management 790. It is convenient for supervisors and patent management staff to obtain more relevant data on intellectual property rights, as well as process various management tasks and instantly support decision-making through the patent management system 100.

The function of intellectual database management 790 within the disclosed patent management system 100 further contains analyses of applications management, resources sharing, patent indexes, developments and applications, competitive vendors, and financial patterns. The function of the financial management 740 further includes payment applications, maintenance fees, bonus issuing, and payments for annual fees. The function of objective management 780 further includes organization objectives, department objectives, employee objectives, and employee appraisals. Innovation management 770 further includes creating surroundings, enrichment inner lives, and encouraging proposals. Training and development management 750 further includes introductions of case recommendations, examples of rights intrusions, new ideas and legislation.

### ACHIEVEMENTS OF THE INVENTION

As previously stated, analyses of technical solutions within the disclosed invention provide many advantages for practical applications,

1. Data can be amended either through a network or a single PC and be uploaded to the server, so as to resolve the problems of insufficient bandwidth or inability to connect to the network;

2. Authorization set-up based on client attributes (such as employees, inventors, patent management staff, office coordinators, supervisors, etc.) to maintain data security;

3. Data maintenance (such as case progress, payments, descriptions, etc.) is divided and co-operated by areas without interference;

4. Data can be examined, inquired and shared;

5. Various required reports can be rapidly integrated;

6. Inventor data can be shared by a one-off key-in without duplicated operations;

7. data can be flexibly outputted through spreadsheets;

8. Management of various payments (such as application fees, maintenance fees, bonuses, etc.) can be clearly viewed;

9. Analyses of application management, patents indexes, developments and applications can be provided for reference while making decisions;

10. The system can monitor the payment status of annual fees for patents;

11. Patent objectives of each subsidiary can be set up in advance to monitor achievement rates.

As previously stated, detailed embodiments of the invention are disclosed herein. However, it is to be understood that the disclosed embodiments are merely exemplary of the invention that may be embodied in various forms. These and other variations, which will be understood by those skilled in the art, are within the intended scope of the invention as claimed below.

What is claimed is:

1. A kind of patent management system is applied to a client/server network, which comprises:
a patent management server system, which is established at the server end, enables a client to access plurality of patent management functions through the client/server network; and
a patent management client system, which is established at the client end, enables a client to access the patent management server system, and, when disconnects from the patent management server system, executes plurality of patent management functions off-line.

2. The system of claim 1, wherein the patent management server system further comprises:
a patent module, providing plurality of the patent management functions;
a response module, receiving a calling message sent from the client end and responding a message for uploading permission; and
an update module, proceeding instant update of a patent data uploaded by the client end.

3. The system of claim 1, wherein the patent management client system further comprises:
a patent module, providing plurality of the patent management functions;
a call module, calling the server for executing data upload and examining an updated patent record at the server end; and
An update module, uploading the patent data to the server end and downloading the patent data from the server end.

4. The system of claim 1, wherein the patent management server system and the patent management client system connect with each other proceeding data transmission through the client/server network.

5. A patent management server system, which is established at the server end comprises:
a patent module, providing plurality of patent management functions, further comprises:
an applications record unit, recording a patent data, a payment record of the patent data, and a client authorization of the patent management system;
an statistical evaluation unit, is to inquire and calculate the patent data that matches an inquired condition and record a evaluation data of the patent data;
an inventor check unit, examining the patent data; and
a supervisor check unit, displaying a high-level managers;
a response module, receiving a calling message sent from the client end and responding a message for uploading permission; and
an update module, proceeding instant update of a patent data uploaded from the client end, further comprises:
an upload-receiving unit, receiving the uploaded patent data;
a search and comparison unit, comparing the data differences between the patent management server system and the patent data at the client end and searching changed and modified data of the patent; and
an examination and update unit, examining changed and modified data of the patent, updating the patent data. For those fields are changed, the original data will be replaced by updated data, for those fields are null (remains blank), the original data will not be replaced.

6. The system of claim 5, wherein the applications record unit further comprises:
a data record unit, recording the patent data;
a report output unit, outputting a report of the patent data;
a payment record unit, recording the payment history of the patent data; and
an authorization set-up unit, recording examination set-up conditions and inquiring the client authorization for using the patent data.

7. The system of claim 6, wherein the payment record unit further provides an instant payment alert.

8. The system of claim 5, wherein the client authorization is selected from the group consisting of: an inquiry authorization and an examination authorization.

9. The system of claim 5, wherein the statistical evaluation unit further comprises:
an evaluation record unit, recording the evaluation data of the patent data;
an inquiry unit, searching the patent data; and
a statistic unit, calculating inquired data conditions that match the patent data.

10. The system of claim 5, wherein the supervisor check unit further comprises:
a factor analysis unit, analyzing output of the evaluation statistic module; and
a supervisor bulletin unit, transferring output of the factor analysis unit to data requirements for the high-level managers.

11. A patent management client system, which is established at the client end of the client/sever network, further comprises:
a patent module, providing plurality of patent management functions, further comprises:
an applications record unit, recording a patent data, a payment record of the patent data, and a client authorization of the patent management system;
an statistical evaluation unit, is to search and calculate that inquired conditions match the patent data and record a evaluation data of the patent data;
an inventor check unit, examining the patent data; and
a supervisor check unit, displaying a high-level manager data;
a call module, calling the server for executing data upload and examining updated patent records at the server end; and
an update module, uploading the patent data to the server end and downloading the patent data from the server end. It further comprises:
an upload-receiving unit, uploading the patent data and downloading the patent data from the server end;
a search and comparison unit, comparing the data differences between the patent management client system and the patent data at the server end and searching changed and modified data of the patent; and
an examination and update unit, examining changed and modified data of the patent, updating the patent data. If the field is changed, the original data will be replaced by updated data, if the field is null (remains blank), the original data will not be replaced.

12. The system of claim 11, wherein examining the updated patent record can be proceeded from the group consisting of: the server, a PC start-up, and set-up execution by the client.

13. The system of claim 11, wherein the application record unit further comprises:
a data record unit, recording the patent data;
a report output unit, outputting a report of the patent data;
a payment record unit, recording the payment history of the patent data; and
an authorization set-up unit, recording examination set-up conditions and inquiring the client authorization for the patent data.

14. The system of claim 13, wherein the payment record unit further provides an instant payment alert.

15. The system of claim 11, wherein the authorization is selected from the group consisting of: an inquiry authorization and an examination authorization.

16. The system of claim 11, wherein the statistical evaluation unit further comprises:
an evaluation record unit, recording the evaluation data of the patent data;
an inquiry unit, searching the patent data; and
a statistic unit, calculating inquired data conditions that match the patent data.

17. The system of claim 11, wherein the supervisor check unit further comprises:
a factor analysis unit, analyzing output of the evaluation statistic module; and
a supervisor bulletin unit, transferring output of the factor analysis unit to data requirements for the high-level managers.

18. A kind of patent management method is applied to a client/server network, which can be connected by a client end to instantly update a patent data through the network. The method further comprises the steps of:
receiving an uploading message and the patent data;
comparing the differences between the patent data and original data, searching patent data that is changed and modified; and
updating the patent data at the server end. For those fields are changed, the original data will be replaced by updated data, if the field is null (remains blank), the original data will not be replaced.

19. The method of claim 18, wherein the server records the uploading messages and the patent data prior to proceed data comparison.
